(19) United States
(12) Patent Application Publication
(10) Pub. No.: US 2011/0243090 A1
(43) Pub. Date: Oct. 6, 2011

(54) DOWNLINK CONTROL AND PHYSICAL HYBRID ARQ INDICATOR CHANNEL (PHICH) CONFIGURATION FOR EXTENDED BANDWIDTH SYSTEM

(75) Inventors: Asbjorn Grovlen, Frederiksberg (DK); Lars Erik Lindh, Helsingfors (FI); Timo Eric Roman, Espoo (FI); Tommi Tapani Koivisto, Espoo (FI)

(73) Assignee: NOKIA CORPORATION, Espoo (FI)

(21) Appl. No.: 13/139,672

(22) PCT Filed: Dec. 9, 2009
(86) PCT No.: PCT/FI2009/050988

§ 371 Date: Jun. 14, 2011

Related U.S. Application Data
(60) Provisional application No. 61/201,784, filed on Dec. 15, 2008.

(51) Int. Cl. H04W 72/04

(52) U.S. Cl. 370/329

(57) ABSTRACT

In accordance with the exemplary embodiments of the invention, there is described herein at least a method, executable computer program, and apparatus to form a resource allocation for a particular bandwidth, including defining at least one search space for a first bandwidth region used by a first user equipment and for a second bandwidth region used by a second user equipment, each search space including control channel elements, where there are first control channel elements in the first bandwidth region and second control channel elements in the second bandwidth region, and transmitting information descriptive of the resource allocation to the first user equipment and the second user equipment.

### TECHNICAL FIELD

The exemplary and non-limiting embodiments of this invention relate generally to wireless communication systems, methods, devices and computer programs and, more specifically, relate to the allocation of wireless communication resources to user equipment.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or drawing figures are defined as follows:
3GPP third generation partnership project
ARQ automatic repeat-request
UTRAN universal terrestrial radio access network
EUTRAN evolved UTRAN (LTE)
LTE long term evolution
Node B base station
eNB EUTRAN Node B (evolved Node B)
UE user equipment
UL uplink (UE towards eNB)
CCE control channel elements
DL downlink (eNB towards UE)
FDD frequency division duplex
MME mobility management entity
S-GW serving gateway
PRB physical resource block
PHY physical (layer 1)
RRC radio resource control
BW bandwidth
OFDMA orthogonal frequency division multiple access
SC-FDMA single carrier, frequency division multiple access
DCI downlink control information
PBCH physical broadcast channel
PCFICH physical control format indicator channel
PDCCH physical downlink control channel
PDSCH physical downlink shared channel
PHICH physical hybrid automatic repeat request indicator channel
RB resource block
RBG resource block group
RE resource element
RS reference symbol
MIB master information block
SIB system information block
MBSFN multicast-broadcast single frequency network
CQI channel quality indicator
TBS transport block size
MCS modulation coding scheme
C-RNTI cell radio network temporary identity

A communication system known as evolved UTRAN (EUTRAN, also referred to as UTRAN-LTE or as E-UTRA) is under development within the 3GPP. As specified the DL access technique will be OFDMA, and the UL access technique will be SC-FDMA.

One specification of interest is 3GPP TS 36.300, V8.5.0 (2008-05), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety. The described system may be referred to for convenience as LTE Rel-8, or simply as Rel-8.

Of further interest herein are the following specifications:

3GPP TS 36.101 V8.3.0 (2008-09) Technical Specification 3rd Generation Partnership Project; Technical Specification Group Radio Access Network; Evolved Universal Terrestrial Radio Access (E-UTRA); User Equipment (UE) radio transmission and reception (Release 8); and

3GPP TS 36.104 V8.3.0 (2008-09) Technical Specification 3rd Generation Partnership Project; Technical Specification Group Radio Access Network; Evolved Universal Terrestrial Radio Access (E-UTRA); Base Station (BS) radio transmission and reception (Release 8), both of which are incorporated by reference herein.

In accordance with 3GPP TS 36.104 and 3GPP TS 36.101 only selected DL and UL system BWs are supported by Rel-8. For FDD these BWs are 1.4 MHz, 3 MHz, 5 MHz, 10 MHz, 15 MHz, and 20 MHz. The standardized system bandwidths are shown in Table 5.1-1 of 3GPP TS 36.104 reproduced herein as FIG. 1.

It may be desirable in some circumstances to enable a better utilization of an arbitrary spectrum allocation in terms of BW, as for example MHz. For example, it may be the case that a certain network operator has, for example, 11 MHz of spectrum available. According to Rel-8, the operator may place on that band, at most, the 10 MHz LTE carrier, leaving the remaining 1 MHz unused, at least for LTE.

In principle it may be possible to achieve any transmission BW for data with LTE Rel-8. For example, and using the values of the preceding paragraph, one may instead of using the 10 MHz system BW use the 15 MHz system BW, and simply not allocate data to the band edges, leaving only 11 MHz of the 15 MHz for the data. However, in 3GPP it has been agreed that the physical downlink control channel (PDCCH) occupies the entire system band (1.4, 3, 5, 10, 15, or 20 MHz). Thus, even if spectrum used for data transmission is reduced from 15 MHz to 11 MHz (in this non-limiting example), the PDCCH would still require the use of the entire 15 MHz BW, thereby exceeding the operator's allocated share of frequency resources. It can thus be appreciated that, in this case, it is not possible to address a larger bandwidth than that used for the PDCCH with DCI formats as defined for LTE Rel-8.

### SUMMARY

In an exemplary aspect of the invention, there is a method, comprising forming a resource allocation for a particular bandwidth, including defining at least one search space for a first bandwidth region used by a first user equipment and for a second bandwidth region used by a second user equipment, each search space comprising control channel elements, where there are first control channel elements in the first bandwidth region and second control channel elements in the second bandwidth region, and transmitting information descriptive of the resource allocation to the first user equipment and the second user equipment.

In another exemplary aspect of the invention, there is a computer readable medium encoded with a computer program executable by a processor to perform actions comprising forming a resource allocation for a particular bandwidth, including defining at least one search space for a first bandwidth region used by a first user equipment and for a second bandwidth region used by a second user equipment, each search space comprising control channel elements, where there are first control channel elements in the first bandwidth region and second control channel elements in the second bandwidth region, and transmitting information descriptive of the resource allocation to the first user equipment and the second user equipment.

In still another exemplary aspect of the invention, there is a an apparatus, comprising at least one processor, and at least one memory including computer program code, where the at least one memory and the computer program code are configured, with the at least one processor, to cause the apparatus to at least form a resource allocation for a particular bandwidth, including defining at least one search space for a first bandwidth region used by a first user equipment and in a second bandwidth region used by a second user equipment, each search space comprising control channel elements, where there are first control channel elements in the first bandwidth region and second control channel elements in the second bandwidth region, and transmit information descriptive of the resource allocation to the first user equipment and the second user equipment.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 reproduces Table 5.1-1 of 3GPP TS 36.104 v8.1.0, and shows LTE Rel-8 system bandwidth options.

FIG. 2 shows a simplified block diagram of various electronic devices that are suitable for use in practicing the exemplary embodiments of this invention.

FIG. 3A shows an extended PDCCH RB space that is addressed by the signaling technique in accordance with the exemplary embodiments of this invention.

FIG. 3B shows mutually exclusive Rel-8 and Rel-9 CCE spaces: Rel-8 CCE space is mapped to REs in Rel-8 PDCCH region; Rel-9 CCE space is mapped to REs Rel-9 extended PDCCH region.

FIG. 3C shows that the CCE space covers both the Rel-8 CCE space and the extended PDCCH region.

FIG. 3D indicates that the Rel-9 CCE space covers only part of the Rel-8 CCE space and the entire extended PDCCH region (it is assumed for convenience that the Rel-8 CCE search space size equals the beyond Rel-8 CCE search space size).

FIG. 3E shows mutually exclusive Rel-8 and Rel-9 PHICH spaces, where the Rel-8 PHICH space is mapped to REs in the Rel-8 PHICH region, and where the Rel-9 PHICH space is mapped to REs in the Rel-9 extended PHICH region.

FIG. 3F illustrates a case where the Rel-9 PHICH space covers both the Rel-8 PHICHCCE space and the extended PHICH region.

FIG. 3G illustrates a case where the Rel-9 PHICH space covers only part of the Rel-8 PHICH space and the entire extended PHICH region.

FIG. 4A reproduces FIG. 6.2.2-1: Downlink Resource Grid, from 3GPP TS 36.211.

FIG. 4B reproduces Table 9.1.1-1: PDCCH candidates monitored by a UE, from 3GPP TS 36.213.

FIG. 5 shows exemplary values for a parameter N_{RB}_{_{—}}^{tot}^{DL} used with different system bandwidths.

FIGS. 6, 7, and 8 are logic flow diagrams which each illustrates the operation of a method, and a result of execution of computer program instructions, in accordance with the exemplary embodiments of this invention.

### DETAILED DESCRIPTION

In accordance with the exemplary embodiments of this invention, techniques are provided which at least allow a UE supporting an extended bandwidth to receive PDCCHs over the entire extended BW, while PDCCHs for Rel-8 UEs would remain compliant with the Rel-8 BW and CCE mapping definitions. Other aspects of this invention cover PHICH (i.e., the DL ACK/NACK channel corresponding to UL transmissions) operation for those UEs that support an extended BW.

The exemplary embodiments of this invention pertain at least in part to the Layer 1 (PHYS) specifications (generally 3GPP 36.2XX)04 and are particularly useful for LTE releases “beyond Rel-8” (e.g., Rel-9, Rel-10 or LTE-Advanced). More specifically these exemplary embodiments pertain at least in part to downlink control signaling to support larger bandwidths. As such, any reference herein in the description or drawings to a “Rel-n”, where n>8, is intended to be read as a reference to “beyond Rel-8”.

The exemplary embodiments of this invention further extend the inventions described in PCT/IB2008/053914, filed 25 Sep. 2008 (NC65617WO), and PCT/IB2008/054449, filed 28 Oct. 2008 (NC65861WO). PCT/IB2008/053914 describes techniques to extend the DL/UL resource allocation mechanisms to address extended bandwidths beyond Rel-8 definitions. PCT/IB2008/054449 describes techniques for expanding the control channel bandwidth while still maintaining backwards compatibility for UEs of earlier release (e.g., Rel-8 UEs). The exemplary embodiments of this invention provide specific hashing function designs for mapping CCEs of both Rel-8 UEs and beyond Rel-8 UEs to the control channel region, while maintaining backwards compatibility for Rel-8 UEs

In general, the set of specifications given generally as 3GPP TS 36.xyz (e.g., 36.104, 36.211, 36.312, etc.) may be seen as describing the entire Rel-8 LTE system. Of particular interest are:

3GPP TS 36.211 V8.4.0 (2008-09) Technical Specification 3rd Generation Partnership Project; Technical Specification Group Radio Access Network; Evolved Universal Terrestrial Radio Access (E-UTRA); Physical channels and modulation (Release 8);

3GPP TS 36.212 V8.4.0 (2008-09) Technical Specification 3rd Generation Partnership Project; Technical Specification Group Radio Access Network; Evolved Universal Terrestrial Radio Access (E-UTRA); Multiplexing and channel coding (Release 8); and

3GPP TS 36.213 V8.4.0 (2008-09) Technical Specification 3rd Generation Partnership Project; Technical Specification Group Radio Access Network; Evolved Universal Terrestrial Radio Access (E-UTRA); Physical layer procedures (Release 8).

Also of interest herein are releases of 3GPP LTE which have been targeted towards wireless communication systems, and which may be referred to herein for convenience simply as LTE-Advanced (LTE-A), or as Rel-9, or as Rel-10. For example, reference can be made to 3GPP TR 36.913, V8.0.0 (2008-06), 3rd Generation Partnership Project; Technical Specification Group Radio Access Network; Requirements for Further Advancements for E-UTRA (LTE-Advanced) (Release X).

In LTE Rel-8 the control channel is decoded blindly, i.e., each UE searches at different locations, defined by a hashing function, for its own PDCCHs. There is both a common and a UE-dedicated search space, and the UE is specified to perform up to 44 blind decoding attempts in a subframe. The hashing function informs each UE of which CCEs to monitor (i.e., decode) for a potential PDCCH transmission, given the subframe number, a common or UE-specific search space and the aggregation level (1, 2, 4, or 8).

According to LTE Rel-8 specifications (see 3GPP TS 36.213, Section 9.1.1), the control region consists of a set of CCEs, numbered from 0 to N_{CCE,k}−1 according to Section 6.8.2 in 3GPP TS 36.211, where N_{CCE,k} is the total number of CCEs in the control region of subframe k. The set of PDCCH candidates to monitor are defined in terms of search spaces, where a search space Sₖ^{(L)} at aggregation level L ∈{1, 2, 4, 8} is defined by a set of PDCCH candidates. The CCE indices corresponding to PDCCH candidate m of the search space Sₖ^{(L)} are given by

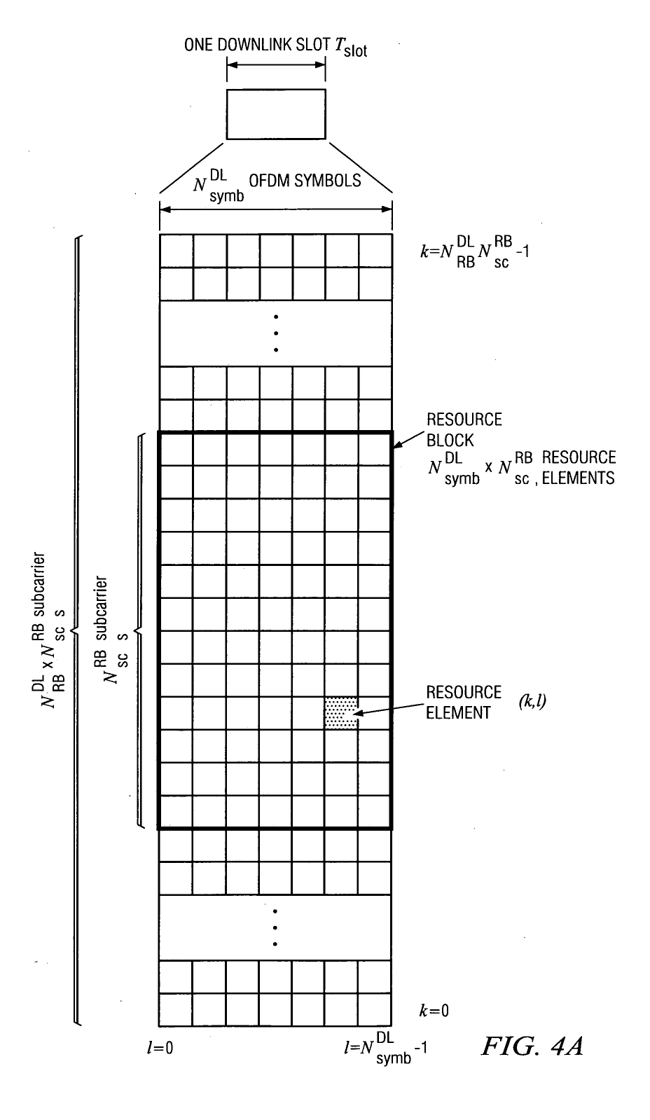

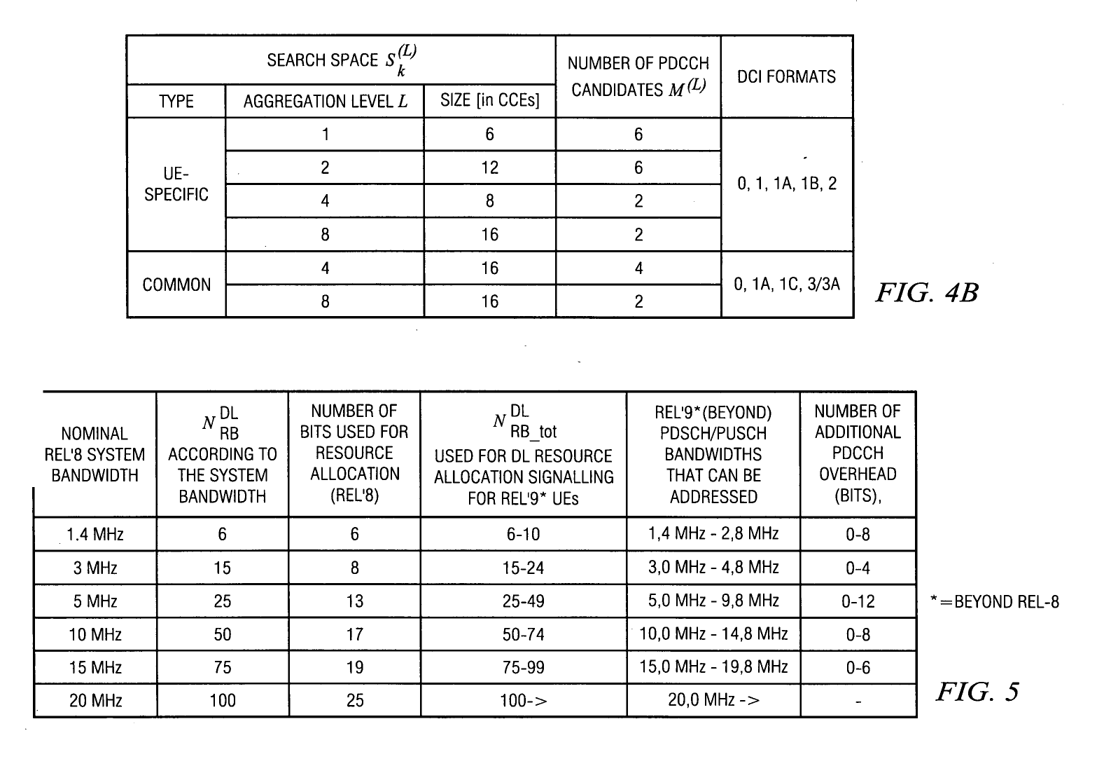

L·{(Yₖ+m)mod└N_{CCE,k}/L┘}+i,

where Yₖ is defined below, i=0, . . . , L−1 and m=0, . . . , M^{(L)}−1. M^{(L)} is the number of PDCCH candidates to monitor in the given search space (see Table 9.1.1-1 in 3GPP TS 36.213, reproduced herein as FIG. 4B).

The UE is specified to monitor one common search space at each of the aggregation levels 4 and 8 and one UE-specific search space at each of the aggregation levels 1, 2, 4, 8. The common and UE-specific search spaces may overlap.

The aggregation levels defining the search spaces and the DCI formats that the UE shall monitor in the respective search spaces are listed in Table 9.1.1-1 (reproduced herein as FIG. 4D). The notation 3/3A implies that the UE shall monitor DCI formats 3 or 3A as determined by the configuration. The DCI formats that the UE shall monitor in the UE specific search spaces is a subset of those listed in Table 9.1.1-1 and depend on the configured transmission mode as defined in Section 7.1.

For the common search spaces, Yₖ is set to 0 for the two aggregation levels L=4 and L=8.

For the UE-specific search space Sₖ^{(L)} at aggregation level L, the variable Yₖ is defined by

Yₖ=(A·Yₖ₋₁)mod D

where Y₋₁=n_{RNTI}≠0, A=39827 _{and D=}65537.

The exemplary embodiments of this invention provide specific solutions in terms of CCE mapping and hashing function design in order to operate the PDCCH for both Rel-8 UEs over Rel-8 BWs and beyond Rel-8 UEs supporting an extended system bandwidth. The PHICH design and operation over the extended BW is also an aspect of the exemplary embodiments of this invention.

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include MME/S-GW functionality, and which provides connectivity with a network 16, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for conducting bidirectional wireless communication 11 with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as an S1 interface. At least the PROG 12C is assumed to include program instructions that, when executed by the associated DP 12A, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNB 12, or by hardware, or by a combination of software and hardware.

For the purposes of describing the exemplary embodiments of this invention there is considered a parameter N_{RB}_{_{—}}^{tot}^{DL} that indicates how many DL RBs can be assigned with the DL grant in the PDCCH, as described below. The parameter N_{RB}_{_{—}}^{tot}^{DL} denotes the total BW in terms of RBs accessible by beyond Rel-8 UEs which comprises of the Rel-8 BW of N_{RB}^{DL} RBs together with N_{RB}_{_{—}}^{ext}^{DL} RBs, which correspond to the extended portion of BW. Hence, the following relationship is fulfilled: N_{RB}_{_{—}}^{tot}^{DL}=N_{RB}^{DL}+N_{RB}_{_{—}}^{ext}^{DL}. The parameter N_{RB}_{_{—}}^{tot}^{DL} is assumed to be equal to or greater than a nominal (or specified) DL BW that equals N_{RB}^{DL} resource blocks.

A second new parameter N_{RB}_{_{—}}^{tot}^{UL} may also be considered that indicates how many UL RBs can be assigned with the UL grant in the PDCCH.

It is assumed that the UE 10 is configured to receive and consider one or both of the new parameters N_{RB}_{_{—}}^{tot}^{DL} and N_{RB}_{_{—}}^{tot}^{UL} .

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A may be of any type suitable to the local technical environment, and may include one or more of general purpose computers, special purpose computers, microprocessors, digital signal processors (DSPs) and processors based on multi-core processor architectures, as non-limiting examples.

As considered herein a “beyond Rel-8” UE 10 is one configured for operation with a release or releases of LTE such as, for example, Rel-9, Rel-10, LTE-Advanced, etc. Note that a beyond Rel-8 UE 10 may also be backward compatible with Rel-8, and may furthermore be a multi-mode type of device that is capable of operation with another type or types of wireless standards/protocols, such as GSM.

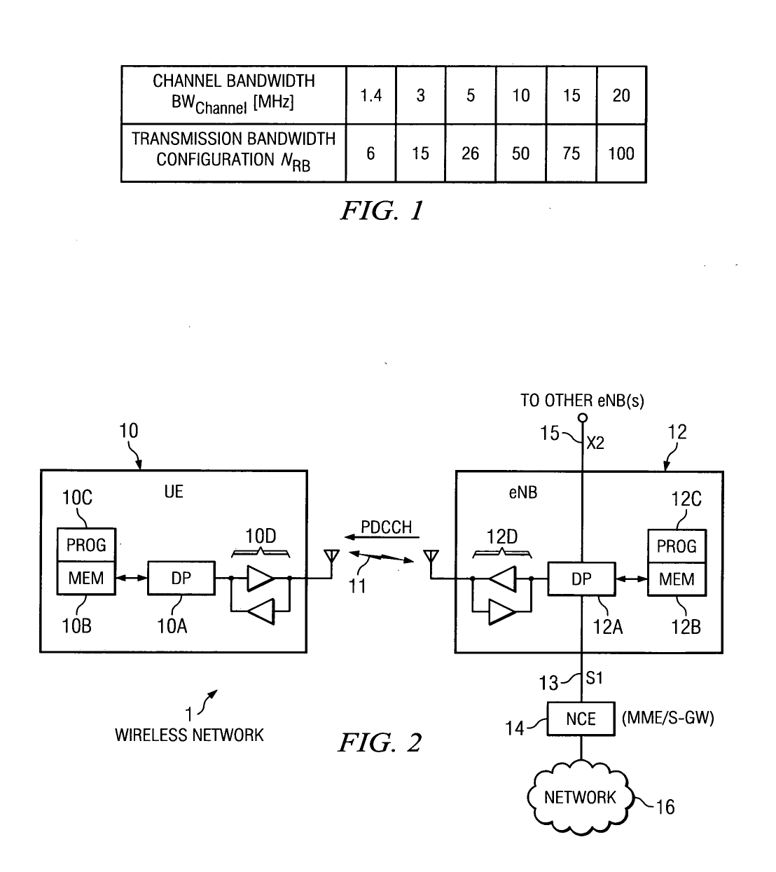

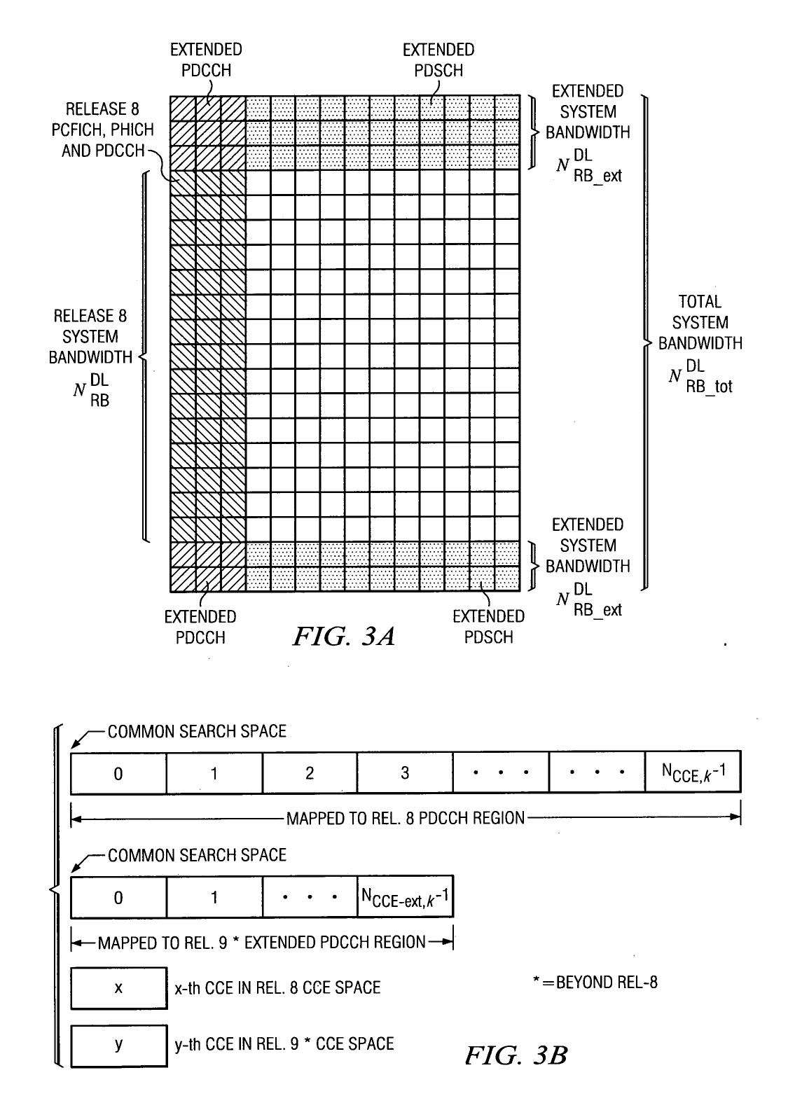

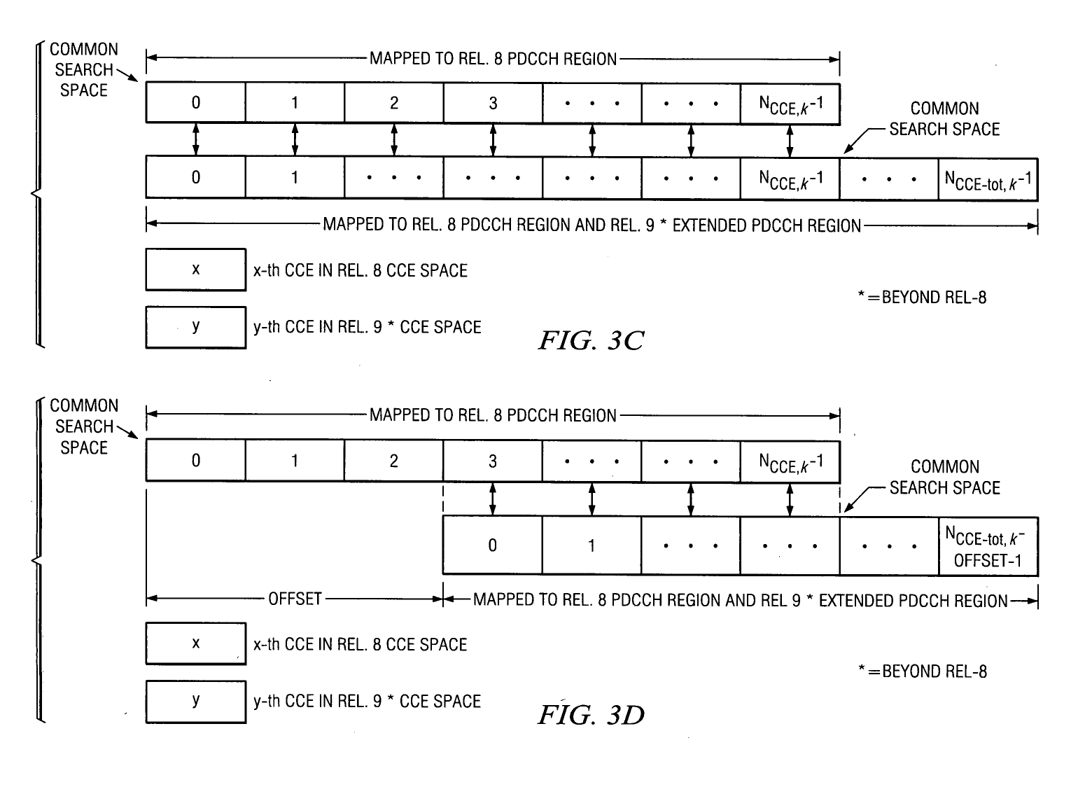

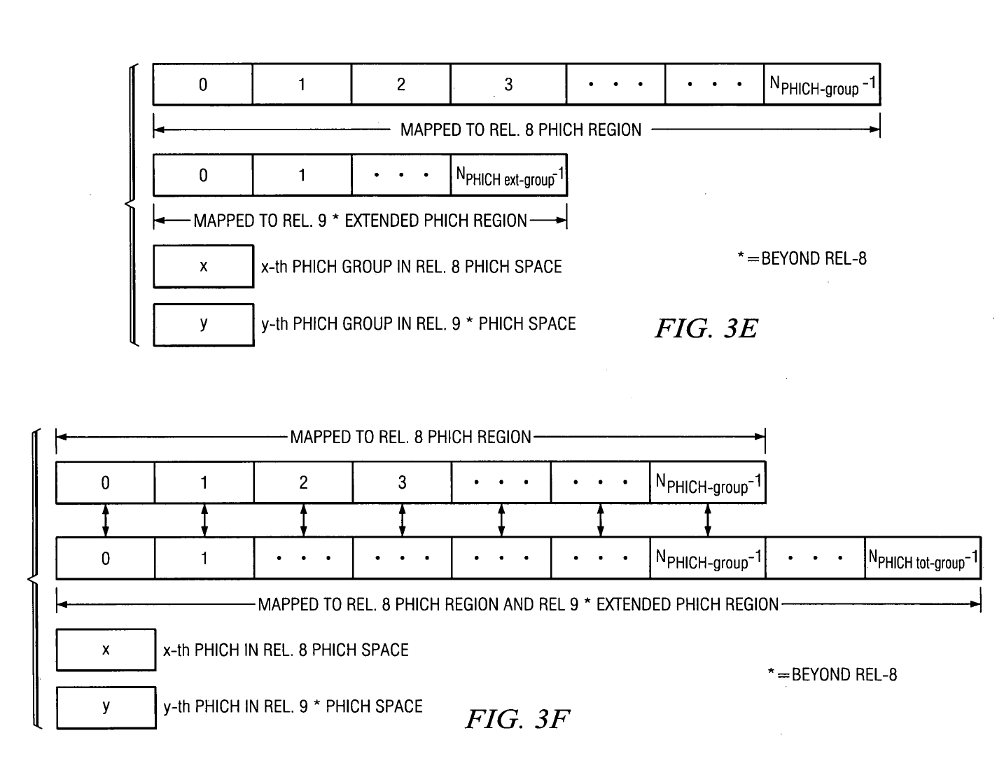

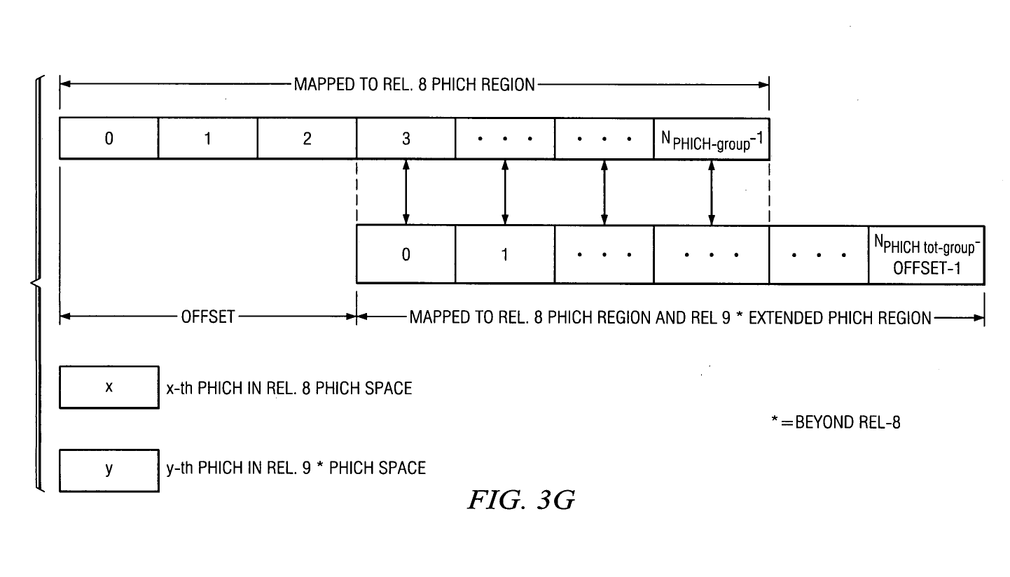

The exemplary embodiments of this invention provide in one aspect thereof a mechanism and process to allocate control channel resources outside of a nominal system BW, such as the exemplary BWs listed in FIG. 1. This is illustrated in FIG. 3A, which shows an extended PDCCH RB space (and an extended PDSCH space) that is addressed by the use of the exemplary embodiments of this invention.

It is noted that PDCCHs may carry DL resource allocation grants or UL resource allocation grants, as examples.

3GPP 36.211 defines certain parameters of interest herein as follows:
N_{RB}^{DL} downlink bandwidth configuration, expressed in multiples of N_{sc}^{RB};
N_{RB}^{min, DL} smallest downlink bandwidth configuration, expressed in multiples of N_{sc}^{RB};
N_{RB}^{max, DL} largest downlink bandwidth configuration, expressed in multiples of N_{sc}^{RB};
N_{sc}^{RB} resource block size in the frequency domain, expressed as a number of subcarriers;
N_{RB}_{UL} uplink bandwidth configuration, expressed in multiples of N_{sc}^{RB};
N_{RB}^{min, UL} smallest uplink bandwidth configuration, expressed in multiples of N_{sc}^{RB};
N_{RB}^{max, UL} largest uplink bandwidth configuration, expressed in multiples of N_{sc}^{RB}.

Typically it is not assumed that N_{RB}^{UL} is equal to N_{RB}^{DL}.

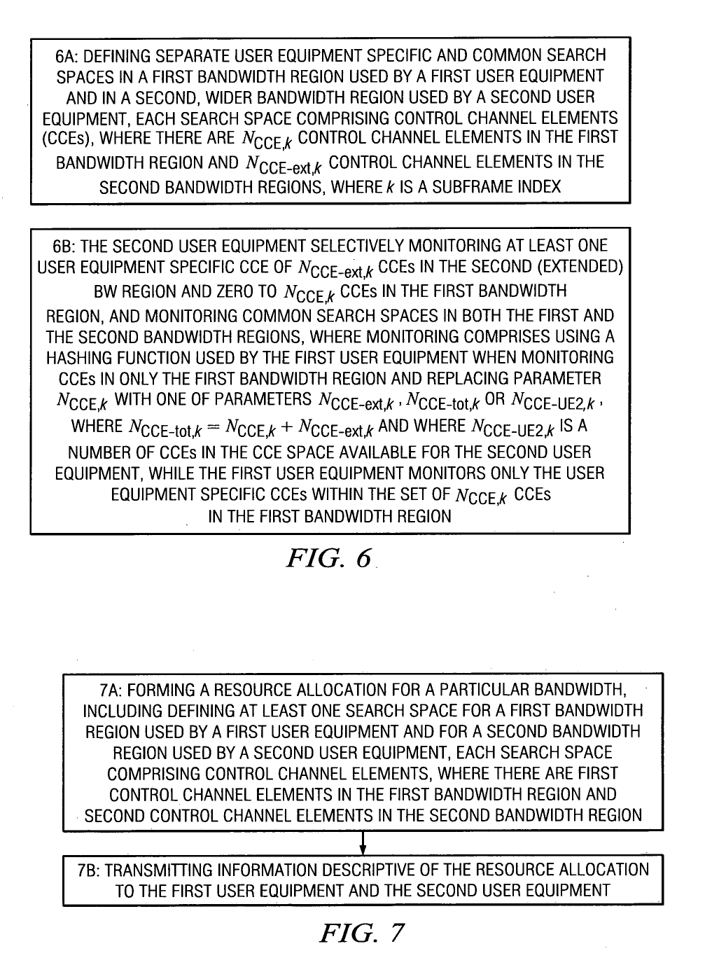

Subclause 6.2.1 of 3GPP TS 36.211, “Resource grid”, states that the transmitted signal in each slot is described by a resource grid of N_{RB}^{DL}N_{sc}^{RB} subcarriers and N_{symb}^{DL} OFDM symbols. The resource grid structure is illustrated in FIG. 6.2.2-1, reproduced herein as FIG. 4A. The quantity N_{RB}^{DL} depends on the downlink transmission bandwidth configured in the cell and shall fulfill
N_{RB}^{min,DL}≦N_{RB}^{DL}≦N_{RB}^{max,DL}
   where N_{RB}^{min,DL}=6 and N_{RB}^{max, DL}=110 are the smallest and largest downlink bandwidth, respectively, supported by the current version of this specification (the Rel-8 LTE specification).

The set of allowed values for N_{RB}^{DL} is given by 3GPP TS 36.104. The number of OFDM symbols in a slot depends on the cyclic prefix length and subcarrier spacing configured and is given in Table 6.2.3-1 of 3GPP TS 36.211.

Subclause 6.2.2, of 3GPP TS 36.211, “Resource elements”, states that each element in the resource grid for antenna port p is called a resource element and is uniquely identified by the index pair (k, l) in a slot where k=0, . . . , N_{RB}^{DL} N_{sc}^{RB}−1 and l=0, . . . , N_{symb}^{DL}−1 are the indices in the frequency and time domains, respectively. Resource element (k, l) on antenna port p corresponds to the complex value a_{k,l}^{(p)}.

Subclause 6.2.3, of 3GPP TS 36.211, “Resource blocks”, states in part that resource blocks are used to describe the mapping of certain physical channels to resource elements. Physical and virtual resource blocks are defined.

A physical resource block is defined as N_{symb}^{DL} consecutive OFDM symbols in the time domain and N_{sc}^{RB} consecutive subcarriers in the frequency domain, where N_{symb}^{DL} and N_{sc}^{RB} are given by Table 6.2.3-1. A physical resource block thus consists of N_{symb}^{DL}×N_{sc}^{RB} resource elements, corresponding to one slot in the time domain and 180 kHz in the frequency domain.

Physical resource blocks are numbered from 0 to N_{RB}^{DL}−1 in the frequency domain. The relation between the physical resource block number n_{PRB} in the frequency domain and resource elements (k, l) in a slot is given by

$${n}_{PRB} = ⌊ \frac{k}{{N}_{sc}^{RB}} ⌋ .$$

The exemplary embodiments of this invention use the resource allocation according to a larger number of RBs (e.g., maximum) than the number N_{RB}^{DL} actually used with a particular system bandwidth, while maintaining the same RBG size P, i.e., the same granularity. This may be achieved by considering another parameter that is used in the derivation of the resource allocation field, i.e., a parameter other than N_{RB}^{DL}. This additional parameter may be referred for convenience, and not as a limitation, as N_{RB}_{_{—}}^{tot}^{DL} .

The parameter N_{RB}_{_{—}}^{tot}^{DL} is defined to indicate how many DL RBs can be assigned with the DL grant in the PDCCH. This parameter replaces the parameter N_{RB}^{DL} in the specification of the resource allocation field of the DL grant for those UEs 10 that are compatible with operation beyond Rel-8 (e.g., LTE-A). The use of the parameter N_{RB}_{_{—}}^{tot}^{DL} effectively scales the resource allocation field so that extended bandwidths can be addressed. The parameter N_{RB}_{_{—}}^{tot}^{DL} may be static, or it may be signaled to the UE 10 using, as a non-limiting example, the MIB on the PBCH, or in a specific SIB (one defined for use with LTE-A). It is also within the scope of these embodiments to make the parameter N_{RB}_{_{—}}^{tot}^{DL} UE-specific, i.e., to configure the extended bandwidth operation separately for each UE 10 by using higher layer signaling (e.g., via RRC signaling).

Furthermore, it is possible to select the value for N_{RB}_{_{—}}^{tot}^{DL} from several alternatives so as to optimize usage for various different BWs.

The Table shown in FIG. 5 lists possible exemplary values for N_{RB}_{_{—}}^{tot}^{DL} that can be used for defining the extended bandwidth that may be utilized for the control signaling for the beyond Rel-8 UEs. The second column from the right shows the bandwidths that can be supported with these values with the granularity of one resource block. As before, references to Rel′9 in FIG. 5 should be read to imply “beyond Rel-8”.

RS support is provided to beyond Rel-8 UEs 10 that may be expected to estimate the wireless channel over the extended bandwidth prior to demodulation of any data transmitted over the extended spectrum. For this purpose Rel-8 cell-specific reference symbols are extended in order to cover the frequency range of the N_{RB}_{_{—}}^{tot}^{DL} RBs, as opposed to the range of the N_{RB}^{DL} RBs in the Rel-8 system.

The current Rel-8 specifications (3GPP TS 36.211) allow for an extension of RBs over a wider system bandwidth in a backward compatible manner for Rel-8 terminals. The reference signal design in 3GPP TS 36.211, Section 6.10.1.2 is such that, prior to being mapped to REs, the RS sequence is always read from indices ranging from N_{RB}^{max, DL}−N_{RB}^{DL} up to N_{RB}^{max, DL}+N_{RB}^{DL}−1, where N_{RB}^{max, DL}=110 RBs is the largest specified DL bandwidth (see again 3GPP TS 36.211, Section 6.2.1).

Assuming now that the additional parameter N_{RB}_{_{—}}^{tot}^{DL} is used in place of N_{RB}^{DL} for mapping RSs to REs, as described in the current specifications, there is achieved a RS mapping over N_{RB}_{_{—}}^{tot}^{DL} RBs. If the BW is extended in a symmetrical manner, i.e., half on each side around the Rel-8 system BW, then the described mapping of RSs to REs results in a specification-compliant mapping for both a Rel-8 UE 10 that accesses the center BW with N_{RB}^{DL} RBs, and a beyond Rel-8 UE 10 that accesses a BW of N_{RB}_{_{—}}^{tot}^{DL} RBs. Asymmetrical BW allocations, if used, may be realized by introducing additional signaling to indicate the location (above or below the center frequency) of the extended RBs. Specific RS sequences are preferably designed to allow for channel estimation over the extended portions of BW in the case of an asymmetrical allocation.

Receive filtering at the UE 10 may set some practical restrictions on the flexibility of the supported bandwidths. The UE 10 may be equipped with a receive filter that can be configured to a certain set of bandwidths, for example in LTE there are six possible bandwidths to which the receive filter can be tuned. Hence, in practice, the beyond Rel-8 UE 10 UE 10 operates with a defined a set of additional bandwidths.

In accordance with the exemplary embodiments of this invention assume the system may be based on one of the existing bandwidths of N_{RB}^{DL} physical resource blocks (PRB) for Rel-8 UEs 10 and in addition the extended bandwidth of N_{RB}_{_{—}}^{tot}^{DL} PRBs, where the control region within N_{RB}^{DL} PRBs is according to the Release 8 specifications, ensuring that a Release 8 UE will be able to connect to the cell. With no changes to the control region this will leave 12×N_{RB}_{_{—}}^{ext}^{DL}×N_{c}=12×(N_{RB}_{_{—}}^{tot}^{DL}−N_{RB}^{DL})×N_{c} resource elements unused if nothing is done (N_{c} is the number of control channel symbols indicated by PCFICH). As described in PCT/IB2008/054449, these REs may be used to provide addition control channel elements (CCE) that can be used for PDCCH, and potentially PHICH, for UEs that support the full N_{RB}_{_{—}}^{tot}^{DL} bandwidth. The exemplary embodiments of this invention provide hashing functions that are designed to allow both Rel-8 UEs to receive the PDCCH over Rel-8 BWs, and the extended BW UEs to receive their PDCCHs over the entire extended BW of N_{RB}_{_{—}}^{tot}^{DL}=N_{RB}^{DL}+N_{RB}_{_{—}}^{ext}^{DL} PRBs.

Assume for a given subframe index k that the Rel-8 control channel space consists of a total number of N_{CCE,k} control channel elements. N_{CCE,k} is computed from the remaining REs in the Rel-8 PDCCH region once resource elements reserved for reference symbols, PHICH and PCFICH have been accounted for. Denote by N_{CCE-tot,k} the total number of CCEs in the CCE space of beyond Rel-8 (e.g., Rel-9) UEs 10 which support operation over an extended BW. Similar to the Rel-8 approach, N_{CCE-tot,k} is computed by taking into account REs reserved for RS, PHICH and PCFICH in the considered PDCCH region for beyond Rel-8 UEs. In the following it is assumed that the PCFICH is defined as in Rel-8, and that it also applies to beyond Rel-8 UEs, i.e., the size of the control region in terms of OFDM symbols is the same for both Rel-8 and beyond Rel-8 UEs 10. In the following discussion it is assumed that there are N_{CCE-ext,k}=N_{CCE-tot,k}−N_{CCE,k} CCEs in the extension region that is accessible only to beyond Rel-8 UEs 10.

An aspect of the invention is a set of search space definitions that allow backwards compatibility for Rel-8 UEs, and at the same time allow beyond Rel-8 UEs to utilize the entire extended set of CCEs (N_{CCE-tot,k}) for the PDCCH decoding, without significantly increasing the number of blind decoding attempts from those required for Rel-8. The beyond Rel-8 UEs 10 monitor CCEs from both the Rel-8 CCE region as well as from the extended region, possibly at the same time, i.e., the search space for these UEs 10 is defined by a combination of CCEs within the set of N_{CCE,k} CCEs in the Rel-8 region and CCEs within the set of N_{CCE-ext,k} CCEs in the extension region (described in further detail below).

In addition to the UE-specific search spaces, and further in accordance with these exemplary embodiments of the invention, the Rel-8 and beyond Rel-8 UEs 10 may also have different common search spaces. In this approach the Rel-8 UE 10 monitors only the Rel-8 region common search space, while the beyond Rel-8 UE 10 monitors the common search spaces in both regions. This is true since a beyond Rel-8 UE 10 needs to know the Rel-8 system information. Broadcast messages intended only for beyond Rel-8 UEs 10 may use the extended PDCCH region. This technique prevents the beyond Rel-8 broadcast messages from overloading the Rel-8 common search space.

The foregoing techniques may be implemented in several manners. Discussed below are three exemplary implementation embodiments, which are not intended to be limiting as to other possible implementation approaches.

### Embodiment E-1

### Mutually Exclusive CCE Spaces

This non-limiting embodiment of the invention employs separate search spaces (both common and/or UE-specific) in the Rel-8 region and in the extension region. The CCEs belonging to these search spaces are located as illustrated in FIG. 3A. As described, N_{CCE-ext,k} is determined by considering exclusively the extended PDCCH region and taking into account those REs reserved for RS and PHICH that may fall therein. A specific hashing function may be designed to provide the UE 10 with candidate CCE locations which are to be monitored. For example, this may be done by re-using the Rel-8 hashing function (see 3GPP TS 36.213, Section 9.1.1) and replacing the parameter N_{CCE,k} therein with the parameter N^{CCE-ext,k}. FIG. 3B illustrates this case, and assumes that the amount of extended BW is less than the Rel-8 BW and, hence, N_{CCE-ext,k}<N_{CCE,k}. However, depending on by how much the Rel-8 bandwidth is extended, the extended control regions may not provide sufficient control channel capacity (i.e., a sufficient number of CCEs) for a beyond Rel-8 UE 10. Also, the full benefits of frequency diversity may not be obtained and, furthermore, if only a small number of Rel-8 UEs 10 are connected to the cell a significant portion of the CCE space may be left unused. To address these potential issues an addition to the hashing function may be used which switches the beyond Rel-8 UE search space between the two CCE regions, for example on a subframe basis. One potential way that this can be realized is by specifying that the used CCE region is a function of subframe number and the C-RNTI (for randomization).

In this case the common search spaces begin in a normal manner at the first CCE of the respective CCE region.

### Embodiment E-2

### Beyond Rel-8 CCE Space Covers Both the Rel-8 CCE Space and the Extended PDCCH Region

This further embodiment of the invention defines an extended search space where CCEs cover the entire extended BW (including the Rel-8 system BW) over the control region defined by the Rel-8 PCFICH (total overlap). For backwards compatibility purposes, PDCCHs intended for Rel-8 UEs in both the common and UE-specific search spaces continue to be addressed according to LTE Rel-8 specifications. A beyond Rel-8 UE 10 operating over the extended system BW uses a specific hashing function covering the full Rel-8 plus the extended BW, and which indicates which CCEs to monitor. In this way the PDCCH capacity increases for beyond Rel-8 UEs. Again, the Rel-8 hashing function may be re-used by considering the new CCE space and replacing the parameter N^{CCE,k} in this case by N_{CCE-tot,k}. FIG. 3C illustrates this case, and it is assumed that the beyond Rel-8 common search space begins where the Rel-8 UE specific search space ends (which is position N_{CCE ,k}). Note that in this case the beyond Rel-8 hashing function wraps around, and the UE specific search spaces may potentially overlap with the Rel-8 common area.

### Embodiment E-3

### Configured Beyond Rel-8 CCE Space Using Part of Rel-8 CCE Space in Addition to Full Usage of Extended PDCCH Region

A third embodiment of this invention includes defining extended search space CCEs which cover the extended PDCCH region and only a portion of the Rel-8 PDCCH region (partial overlap). The use of this embodiment favours CCE allocations for beyond Rel-8 UEs 10 and would limit their impact on Rel-8 PDCCH capacity, resulting in reduced blocking of the Rel-8 PDCCH. This embodiment can be useful when the number of beyond Rel-8 UEs 10 is smaller than the number Rel-8 UEs. A balance between how much the beyond Rel-8 UEs make use of the Rel-8 CCE space can be made configurable (e.g., by using the MIB or the SIBs), but here for simplicity one may assume that the usage of the Rel-8 CCE space is such that the number of CCEs in the beyond Rel-8 UE search space equals N_{CCE,k}. The Rel-8 hashing function can be re-used by considering the new CCE space, and potentially replacing the parameter N_{CCE,k} by the actual CCE space size in the case that a non-equal size is used as compared to Rel-8. FIG. 3D illustrates this case. In this embodiment the starting position of the beyond Rel-8 region is shifted to the right by an offset with respect to the Rel-8 region. If this offset is larger than 16 CCEs then the beyond Rel-8 UE specific search space does not collide with the Rel-8 common search space. The offset can be defined to be either cell-specific or UE-specific. The hashing function may be similarly written as:

Offset+L·{(Yₖ+m)mod└(N_{CCE-tot,k}−offset)/L┘}+i

Embodiment E-3 may be considered as the most advantageous for use in the extended BW system for providing backwards compatibility with Rel-8 UEs.

Discussed now is PHICH operation over an extended bandwidth for beyond Rel-8 UEs 10.

The physical hybrid-ARQ indicator channel (PHICH) contains the acknowledgement signals corresponding to UL transmissions. Logically the PHICH is organized into PHICH groups, each containing eight orthogonal sequence indexes within the group, each corresponding to an Ack/Nack signal. There are implicit rules that associate a PHICH group and sequence number to the corresponding uplink grant, as specified in 3GPP TS 36.213. The number of PHICH groups N_{PHICH}^{group} is constant in all sub-frames and depends on the number of resource blocks as follows:

$${N}_{PHICH}^{group} = \{ \begin{matrix}\vert {N}_{g} ( {N}_{RB}^{DL} / 8 ) \vert for normal cyclic prefix \\ 2 \cdot ⌈ {N}_{g} ( {N}_{RB}^{DL} / 8 ) ⌉ for extended cyclic prefix\end{matrix}$$

where N_{g}∈{1/6 , 1/2, 1, 2} is provided by higher layers.

A PHICH group contains eight Ack/Nack signals and is mapped, after different operations, to 12 resource elements, as specified in 3GPP TS 36.211.

The exemplary embodiments of this invention assume that the same relationship exists between the PHICH regions, as was assumed for the PDCCH regions, for Rel-8 and beyond Rel-8. The embodiments E-1, E-2 and E-3 above, with respect to the PDCCHs, can be assumed to have a corresponding structure for the PHICH. The only structural difference is that the PHICH region is only one area, in contrast to the PDCCH region which is divided into the common and the UE-specific search spaces. FIGS. 3E, 3F and 3G show the organization of the PHICH in a corresponding manner as for the PDCCH. The offset variable in FIG. 3G may be made configurable, or alternatively the offset value may be implied by the offset value used in FIG. 3D for the PDCCH case.

These exemplary embodiments provide a number of advantages and technical effects, such as providing an approach where no resource elements are wasted leading to higher PDCCH capacity. The embodiments B and C also have the advantage of being able to utilize the entire frequency band for the PDCCH, resulting in enhanced frequency diversity. In addition, the search space definitions of embodiments B and C enable beyond Rel-8 UEs to utilize CCEs from both the Rel-8 region and the extension region without severely increasing the blocking of Rel-8 UEs.

Based on the foregoing it should be apparent that the exemplary embodiments of this invention provide a method, apparatus and computer program(s) to provide an enhanced operation for a first user equipment operating in accordance with a first bandwidth region, and for a second user equipment capable of operating in accordance with a second, possibly wider bandwidth region.

(A) Referring to FIG. 6, in accordance with a method, and a result of execution of computer program instructions, at Block 6A there is a step of defining separate user equipment specific and common search spaces in a first bandwidth region used by a first user equipment and in a second, wider bandwidth region used by a second user equipment, each search space comprising control channel elements (CCEs), where there are N_{CCE,k} control channel elements in the first bandwidth region and ^{N}_{CCE-ext,k} control channel elements in the second bandwidth regions, where k is a subframe index, and, at Block 6B, the second user equipment selectively monitoring at least one user equipment specific CCE of N_{CCE-ext,k} CCEs in the second (extended) BW region and zero to N_{CCE,k} CCEs in the first bandwidth region, and monitoring common search spaces in both the first and the second bandwidth regions, where monitoring comprises using a hashing function used by the first user equipment when monitoring CCEs in only the first bandwidth region and replacing parameter N_{CCE,k} with one of parameters N_{CCE-ext,k}, N_{CCE-tot,k} or N_{CCE-UR2,k}, where N_{CCE-tot,k}=N_{CCE,k}+N_{CCE-ext,k} and where N_{CCE-UE2,k} is a number of CCEs in the CCE space available for the second user equipment, while the first user equipment monitors only the user equipment specific CCEs within the set of N_{CCE,k} CCEs in the first bandwidth region.

(B) The method of paragraph (A), where search spaces in the first and the second bandwidth regions are mutually exclusive, and where the hashing function switches the search space CCEs between the first and the second bandwidth regions, such as on a subframe basis.

(C) The method of paragraph (A), where CCEs of the search space of the second bandwidth region totally overlap the CCEs of the first bandwidth region.

(D) The method of paragraph (A), where CCEs of the search space of the second bandwidth region partially overlap the CCEs of the first bandwidth region.

(E) The method of paragraph (D), where a starting position of CCEs of the search space of the second bandwidth region are shifted by an offset with respect to the CCEs of the of the search space of the first bandwidth region, where if the offset is larger than a predetermined amount a user equipment specific search space does not collide with the common search space of the first bandwidth region.

(F) The method of paragraph (E), where the offset is one of cell-specific or user equipment-specific, and where the hashing function is given by:

Offset+L·{(Yₖ+m)mod└(N_{CCE-tot,k}−offset)/L┘}+i.

(G) The method of the preceding paragraphs (A)-(F), where the CCEs of the common and user equipment-specific search spaces are monitored for detecting physical downlink control channels.

(H) The method of the preceding paragraphs (A)-(F), where the CCEs are monitored in a single user equipment-specific search space for detecting physical hybrid ARQ indicator channels.

A) Referring to FIG. 7, in accordance with a method, and a result of execution of computer program instructions, at Block 7A there is a step of forming a resource allocation for a particular bandwidth, including defining at least one search space for a first bandwidth region used by a first user equipment and in a second bandwidth region used by a second user equipment, each search space comprising control channel elements, where there are first control channel elements in the first bandwidth region and second control channel elements in the second bandwidth region, and, at Block 7B, Transmitting information descriptive of the resource allocation to the first user equipment and the second user equipment.

(B) The method of the preceding paragraph (A), where the information specifies the second user equipment selectively monitor at least one control channel element of at least one of said second control channel elements in the second bandwidth region and said first control channel elements in the first bandwidth region, and specifies the first user equipment monitor only the user equipment specific control channel elements within the first control channel elements in the first bandwidth region, where monitoring comprises using a hashing function.

(C) The method of the preceding paragraph (A), where said first control channel elements comprise N_{CCE,k} control channel elements and said second control channel elements comprise N_{CCE-ext,k} control channel elements, where N is an integer and where k is a subframe index.

(D) The method of at least the preceding paragraph (C), comprising replacing the parameter N_{CCE,k} with one of parameters N_{CCE-ext,k}, N_{CCE-tot,k} or N_{CCE-UE2,k}, where N_{CCE-tot,k}=N_{CCE,k}+N_{CCE-ext,k}, where N_{CCE-UE2,k} is a number of control channel elements in the control channel element space available for the second user equipment.

(E) The method of at least the preceding paragraph (B), where search spaces in the first and the second bandwidth regions are mutually exclusive.

(F) The method of at least the preceding paragraph (A), where control channel elements of the at least one search space of the second bandwidth region totally overlap the control channel elements of the first bandwidth region.

(G) The method of at least the preceding paragraph (F), where control channel elements of the at least one search space of the second bandwidth region partially overlap the control channel elements of the first bandwidth region.

(H) The method of at least the preceding paragraph (G), where a starting position of control channel elements of the search space of the second bandwidth region are shifted by an offset with respect to the control channel elements of the of the search space of the first bandwidth region, where if the offset is larger than a predetermined amount a user equipment specific search space does not overlap with a common search space of the first bandwidth region.

(I) The method of at least the preceding paragraph (H), where the offset is one of cell-specific or user equipment-specific, and where the hashing function is given by:

Offset+L·{(Yₖ+m)mod└(N_{CCE-tot,k}−offset)/L┘}+i

where k is a subframe index, where L is an aggregation level, where i is an integer, and where m is a physical downlink control channel candidate of a search space.

(J) The method of at least the preceding paragraph (A), where the at least one search space for the first bandwidth region and for the second bandwidth region are monitored for detecting physical downlink control channels.

(K) The method of at least the preceding paragraph (A), where the control channel elements are monitored in a single user equipment-specific search space for detecting physical hybrid automatic repeat-request indicator channels.

(L) The method of at least the preceding paragraph (E), where the hashing function switches the search space control channel elements between subframes of the first and the second bandwidth regions.

(M) The method of at least the preceding paragraph (A), where defining at least one search space comprises defining separate user equipment specific and common search spaces in at least one of the first and second bandwidth regions.

(N) The method of at least the preceding paragraph (B), where monitoring comprises monitoring at least one user equipment specific control channel element in at least one of the first and second bandwidth regions.

(O) The method of at least the preceding paragraph (B), where monitoring comprises monitoring common search spaces in at least one of the first and second bandwidth regions.

(P) The method of at least the preceding paragraph (B), where the hashing function switches the search space control channel elements between subframes of the first and the second bandwidth regions.

(Q) The method of at least the preceding paragraphs (N) and (O), where common and user equipment-specific search spaces are monitored to detect physical downlink control channels.

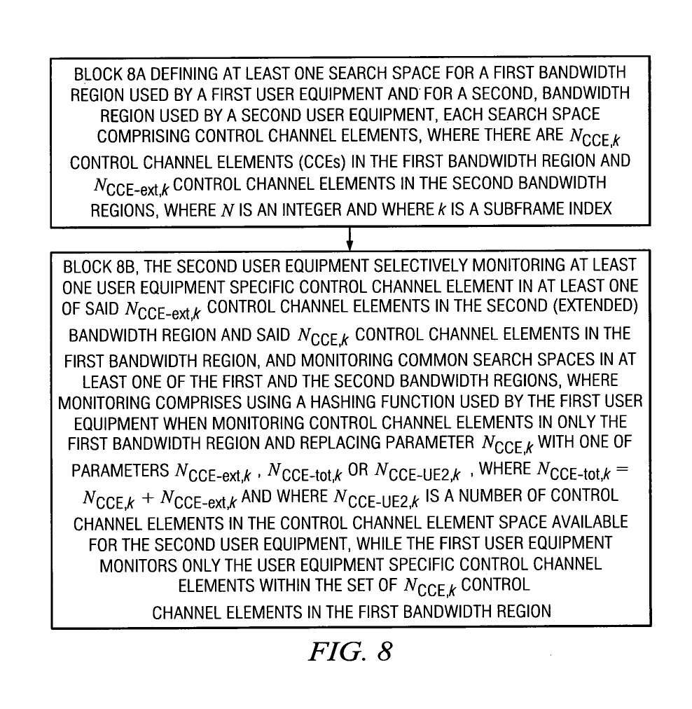

Referring to FIG. 8, in accordance with a method, and a result of execution of computer program instructions, at Block 8A there is a step of defining at least one search space for a first bandwidth region used by a first user equipment and for a second bandwidth region used by a second user equipment, each search space comprising control channel elements, where there are N_{CCE,k} control channel elements in the first bandwidth region and N_{CCE-ext,k} control channel elements in the second bandwidth regions, where N is an integer and where k is a subframe index, and at Block 8B, the second user equipment selectively monitoring at least one user equipment specific CCE in at least one of said N_{CCE-ext,k} control channel elements in the second (extended) bandwidth region and said N_{CCE,k} control channel elements in the first bandwidth region, and monitoring common search spaces in at least one of the first and the second bandwidth regions, where monitoring comprises using a hashing function used by the first user equipment when monitoring control channel elements in only the first bandwidth region and replacing parameter N_{CCE,k} with one of parameters N_{CCE-ext,k}, N_{CCE-tot,k} or N_{CCE-UE2,k}, where N_{CCE-tot,k}=N_{CCE,k}+N_{CCE-ext,k} and where N_{CCE-UE2,k} is a number of control channel elements in the control channel element space available for the second user equipment, while the first user equipment monitors only the user equipment specific control channel elements within the set of N_{CCE,k} control channel elements in the first bandwidth region.

The various blocks shown in FIGS. 6, 7, and 8 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, and as was noted above, it should be appreciated that at least some aspects of the exemplary embodiments of the inventions may be practiced in various components such as integrated circuit chips and modules.

It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be further noted that the UL BW may be equal to the DL BW, or the UL BW may be different than the DL BW. In either case the exemplary embodiments of this invention may be used to provide the above-noted advantages and technical effects.

Note that in some cases then there may be one or more than one extended bandwidth-related parameters that need to be signaled to the RARU 10E of the UE 10 (depending on whether the bandwidth extension occurs in the DL, in the UL, or in both the DL and the UL). As was indicated above, this signaling may occur in a MIB, in a SIB and/or by RRC signaling, as non-limiting examples.

Further by example, the use of these exemplary embodiments can enable the Rel-8 TBS tables to be used as they are by reading an entry corresponding to a selected MCS and the number of allocated PRBs, or new TBS tables may be defined if higher peak data rates are desired.

Further by example, and as was noted above, the BW extension made possible by the use of these exemplary embodiments may be cell-specific or it may be UE-specific.

Further by example, while the exemplary embodiments have been described above in the context of the EUTRAN (UTRAN-LTE) system and enhancements and updates thereto, it should be appreciated that the exemplary embodiments of this invention are not limited for use with only this one particular type of wireless communication system, and that they may be used to advantage in other wireless communication systems.

Clearly the use of the exemplary embodiments provides a further technical effect in that it enables beyond Rel-8 UEs 10 to co-exist with Rel-8 UEs in the same cell, while taking advantage of the extended resource allocations.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., N_{RB}_{_{—}}^{tot}^{DL}, N_{RB}_{_{—}}^{tot}^{UL}, N_{CCE,k}, N_{CCE-tot,k}, CCE, etc.) are not intended to be limiting in any respect, as these parameters may be identified by any suitable names. Further, the formulas and expressions that use these various parameters may differ from those expressly disclosed herein. Further, the various names assigned to different channels (e.g., PDCCH, PDSCH, PHICH, PCFICH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
forming a resource allocation for a particular bandwidth, including defining at least one search space for a first bandwidth region used by a first user equipment and for a second bandwidth region used by a second user equipment, each search space comprising control channel elements, where there are first control channel elements in the first bandwidth region and second control channel elements in the second bandwidth region; and
transmitting information descriptive of the resource allocation to the first user equipment and the second user equipment.

2. The method according to claim 1, where the information specifies the second user equipment selectively monitor at least one control channel element of at least one of said second control channel elements in the second bandwidth region and said first control channel elements in the first bandwidth region, and specifies the first user equipment monitor only the control channel elements within the first control channel elements in the first bandwidth region, where monitoring comprises using a hashing function.

3. The method according to claim 1, where said first control channel elements comprise N_{CCE,k} control channel elements and said second control channel elements comprise N_{CCE -ext,k} control channel elements, where N is an integer and where k is a subframe index.

4. The method according to claim 3, comprising replacing the parameter N_{CCE,k} with one of parameters N_{CCE-ext,k}, N_{CCE-tot,k} or N_{CCE-UE2,k}, where N_{CCE-tot,k}=N_{CCE,k}+N_{CCE-ext,k}, where N_{CCE-UE2,k} is a number of control channel elements in a control channel element space available for the second user equipment.

5. The method according to claim 1, where search spaces of the first and the second bandwidth regions are mutually exclusive.

6. The method according to claim 1, where control channel elements of the at least one search space of the second bandwidth region totally overlap the control channel elements of the first bandwidth region.

7. The method according to claim 1, where control channel elements of the at least one search space of the second bandwidth region partially overlap the control channel elements of the first bandwidth region.

8. The method according to claim 2, where a starting position of control channel elements of the at least one search space of the second bandwidth region are shifted by an offset with respect to the control channel elements of the at least one search space of the first bandwidth region, where when the offset is larger than a predetermined amount a user equipment specific search space does not overlap with a common search space of the first bandwidth region.

9. The method according to claim 8, where the offset is one of cell-specific or user equipment-specific, and where the hashing function is given by:
Offset+L·{(Yₖ+m)mod└(N_{CCE-tot,k}−offset)/L┘}+i
where k is a subframe index, where L is an aggregation level, where i is an integer, and where m is a physical downlink control channel candidate of a search space.

10. The method according to claim 2, where the control channel elements of the at least one search space for the first bandwidth region and for the second bandwidth region are monitored for detecting physical downlink control channels.

11. The method according to claim 2, where the control channel elements are monitored in a single user equipment-specific search space for detecting physical hybrid automatic repeat-request indicator channels.

12. A computer readable medium encoded with a computer program executable by a processor to perform actions comprising:
forming a resource allocation for a particular bandwidth, including defining at least one search space for a first bandwidth region used by a first user equipment and for a second bandwidth region used by a second user equipment, each search space comprising control channel elements, where there are first control channel elements in the first bandwidth region and second control channel elements in the second bandwidth regions; and
transmitting information descriptive of the resource allocation to the first user equipment and the second user equipment.

13. The computer readable medium according to claim 12, where the information specifies the second user equipment selectively monitor at least one control channel element of at least one of said second control channel elements in the second bandwidth region and said first control channel elements in the first bandwidth region, and specifies the first user equipment monitor only the control channel elements within the first control channel elements in the first bandwidth region, where monitoring comprises using a hashing function.

14. The computer readable medium according to claim 12, where said first control channel elements comprise N_{CCE,k} control channel elements and said second control channel elements comprise N_{CCE-ext,k} control channel elements, where Nis an integer and where k is a subframe index.

15. The computer readable medium according to claim 14, comprising replacing the parameter N_{CCE,k} with one of parameters N_{CCE-ext,k}, N_{CCE-tot,k} or N_{CCE-UE2,k}, where N_{CCE-tot,k}=N_{CCE,k}+N_{CCE-ext,k}, where N_{CCE-UE2,k} is a number of control channel elements in a control channel element space available for the second user equipment.

16. An apparatus, comprising:
at least one processor; and
at least one memory including computer program code, where the at least one memory and the computer program code are configured, with the at least one processor, to cause the apparatus to at least:
form a resource allocation for a particular bandwidth, including defining at least one search space for a first bandwidth region used by a first user equipment and for a second bandwidth region used by a second user equipment, each search space comprising control channel elements, where there are first control channel elements in the first bandwidth region and second control channel elements in the second bandwidth regions; and
transmit information descriptive of the resource allocation to the first user equipment and the second user equipment.

17. The apparatus according to claim 16, where the information specifies the second user equipment selectively monitor at least one control channel element of at least one of said second control channel elements in the second bandwidth region and said first control channel elements in the first bandwidth region, and specifies the first user equipment monitor only the control channel elements within the first control channel elements for the first bandwidth region, where monitoring comprises using a hashing function.

18. The apparatus according to claim 16, where said first control channel elements comprise N_{CCE,k} control channel elements and said second control channel elements comprise N_{CCE-ext,k} control channel elements N_{CCE-ext,k}, where N is an integer and where k is a subframe index.

19. The apparatus according to claim 18, comprising the at least one memory and the computer program code are configured, with the at least one processor, to cause the apparatus to replace the parameter N_{CCE,k} with one of parameters N_{CCE-ext,k}, N_{CCE-tot,k} or N_{CCE-UE2,k}, where N_{CCE-tot,k}=N_{CCE,k}+N_{CCE-ext,k}, where N_{CCE-UE2,k} is a number of control channel elements in a control channel element space available for the second user equipment.

20. The apparatus according to claim 16, where search spaces in the first and the second bandwidth regions are mutually exclusive.
